(19) United States
(12) Patent Application Publication
(10) Pub. No.: US 2012/0299463 A1
(43) Pub. Date: Nov. 29, 2012

(54) LIGHT EMITTING DEVICE AND ILLUMINATION APPARATUS USING SAME

(76) Inventor: Rei KUME, Osaka (JP)

(21) Appl. No.: 13/477,352

(22) Filed: May 22, 2012

(30) Foreign Application Priority Data
May 25, 2011 (JP) 2011-116464

(51) Int. Cl. H01J 1/62

(52) U.S. Cl. 313/498

(57) ABSTRACT

A light emitting device includes a solid-state light emitting element; a substrate mounted with the solid-state light emitting element; and a wavelength converting member covering an emission surface of the solid-state light emitting element, the wavelength converting member being formed of a transparent resin containing a fluorescent material. The wavelength converting member includes a first fluorescent material layer provided around the solid-state light emitting element, the first fluorescent material layer being substantially equal in height to an upper surface of the solid-state light emitting element, and a second fluorescent material layer provided to cover the solid-state light emitting element and the first fluorescent material layer, and wherein the second fluorescent material layer is higher in fluorescent material concentration than the first fluorescent material layer, the first fluorescent material layer having a lateral surface exposed and not covered with the second fluorescent material layer.

### FIELD OF THE INVENTION

The present invention relates to a light emitting device employing a solid-state light emitting element as a light source and an illumination apparatus using same.

### BACKGROUND OF THE INVENTION

A light emitting diode (hereinafter referred to as “LED”) is capable of emitting high-illuminance light with a low level of electric power and is used as a light source for various kinds of electric devices such as a signal lamp and a lighting instrument. In recent years, a blue LED as well as red and green LEDs is put into practical use. Light of many different colors can be generated by combining the red, green and blue LEDs. There is known a so-called white LED in which yellow light is outputted by bringing the light of a blue LED into contact with a fluorescent material and in which white light is generated by mixing the yellow light with blue light. The white LED is superior in emission intensity and emission efficiency. A light emitting device employing the white LED is used as a light-diffusing lighting instrument such as a ceiling light or a base light and as a light-collecting lighting instrument such as a down-light or a spot light.

A typical white LED is formed by coating a blue LED chip with a light-transmitting resin containing a yellow fluorescent material. Therefore, the area for emitting yellow light is larger than the area for emitting blue light (the emission surface of the blue LED chip). For that reason, as shown in FIG. 9, the blue light emitted from a white LED 102 is irradiated on the central region and the yellow light emitted from the white LED 102 is irradiated on the peripheral region. Therefore, color unevenness is sometimes generated on an irradiated surface.

There is known a light emitting device in which color unevenness is reduced by forming a high-concentration resin layer having a high concentration of yellow fluorescent material on the upper surface of an LED, forming a low-concentration resin layer having a low concentration of fluorescent material in the peripheral region of the LED and consequently increasing the yellow color component of the light emitted toward the upper surface of the LED (see, e.g., Japanese Patent Application Publication No. 2004-111882 (JP2004-111882A)).

In recent years, there is developed a technology in which a fluorescent material layer is formed by directly applying a resin containing a fluorescent material into an LED package from an inkjet type nozzle while controlling the application amount of the resin. There is also known a light emitting device manufactured by performing an inkjet resin application process in two steps so that the emitted light can fall within a specified color temperature range (see, e.g., Japanese Patent Application Publication No. 2009-260244 (JP2009-260244A)).

In the light emitting device disclosed in JP2004-111882A, the low-concentration resin layer is covered with the high-concentration resin layer. With this configuration, the blue light transmitting the low-concentration resin layer and the yellow light wavelength-converted by the low-concentration resin layer are all transmitted through the high-concentration resin layer existing on the upper surface of the low-concentration resin layer and are projected from the light emitting device. For that reason, the projection amount of the yellow light wavelength-converted when transmitting the high-concentration resin layer grows larger in the wide-angled peripheral direction than in the light output direction of the light emitting device. It is therefore likely that color unevenness is generated on an irradiated surface. In addition, a cup is provided at the lateral side of the low-concentration resin layer. This makes it difficult to distribute the projected light at a wide angle.

In the light emitting device disclosed in JP2009-260244A, the fluorescent material layer is formed by injecting a resin containing a fluorescent material into a recess portion of a molded body making up a package. Therefore, the molded body exists at the lateral side of the fluorescent material. This makes it difficult to distribute the projected light at a wide angle. Among the light emitted from the LED and the light converted by the fluorescent material, the light projected toward the lateral side is multi-reflected by the molded body and is not projected outside the light emitting device. Since the light projected toward the lateral side is not used as effective light, the light utilization efficiency is likely to grow worse.

### SUMMARY OF THE INVENTION

In view of the above, the present invention provides a light emitting device capable of making color unevenness hard to occur, distributing the projected light at a wide angle and enjoying enhanced light utilization efficiency, and an illumination apparatus using the light emitting device.

In accordance with one aspect of the present invention, there is provided a light emitting device, including: a solid-state light emitting element; a substrate mounted with the solid-state light emitting element; and a wavelength converting member covering an emission surface of the solid-state light emitting element, the wavelength converting member being formed of a transparent resin containing a fluorescent material, wherein the wavelength converting member includes a first fluorescent material layer provided around the solid-state light emitting element, the first fluorescent material layer being substantially equal in height to an upper surface of the solid-state light emitting element, and a second fluorescent material layer provided to cover the solid-state light emitting element and the first fluorescent material layer, and wherein the second fluorescent material layer is higher in fluorescent material concentration than the first fluorescent material layer, the first fluorescent material layer having a lateral surface exposed and not covered with the second fluorescent material layer.

Preferably, the first fluorescent material layer may be formed to cover, with a thin thickness, the upper surface of the solid-state light emitting element.

Preferably, the wavelength converting member may be formed to have a triangular shape when seen in a vertical section view.

In accordance with another aspect of the present invention, there is provided an illumination apparatus comprising the light emitting device of the one aspect of the present invention.

With the light emitting device of the present invention, the light component of the solid-state light emitting element in the light projected upward from the solid-state light emitting element is reduced by the second fluorescent material layer, which makes it possible to reduce color unevenness. The wavelength-converted component in the light projected in the lateral direction of the solid-state light emitting element is reduced by the first fluorescent material layer, which makes it possible to reduce color unevenness. Accordingly, it is possible to reduce color unevenness caused by the entire light projected from the wavelength converting member. Since the light can be projected at a wide angle from the lateral surface of the first fluorescent material layer, it is possible to enhance the light utilization efficiency.

### BRIEF DESCRIPTION OF THE DRAWINGS

The objects and features of the present invention will become apparent from the following description of embodiments, given in conjunction with the accompanying drawings, in which:

FIG. 1 is a side section view of a light emitting device according to a first embodiment of the present invention;

FIGS. 2A to 2E are side section views for explaining a manufacturing process of the light emitting device of the first embodiment;

FIG. 3 is a side section view of a light emitting device according to one modified example of the first embodiment;

FIGS. 4A to 4E are side section views for explaining a manufacturing process of the light emitting device according to one modified example of the first embodiment;

FIG. 5A is a side section view of a light emitting device according to another modified example of the first embodiment and FIG. 5B is a side section view illustrating a light distribution curve of the light emitting device;

FIG. 6A is a side section view of a light emitting device according to a further modified example of the first embodiment and FIG. 6B is a side section view illustrating a light distribution curve of the light emitting device;

FIG. 7A is a side section view of an illumination apparatus using a light emitting device according to a second embodiment of the present invention and FIG. 7B is a plan view of the illumination apparatus;

FIG. 8A is a side section view of a illumination apparatus using a light emitting device according to one modified example of the second embodiment and FIG. 8B is a plan view of the illumination apparatus; and

FIG. 9 is a view for explaining a cause of generation of color unevenness on an irradiated surface in a conventional light emitting device.

### DETAILED DESCRIPTION OF THE PREFERRED EMBODIMENTS

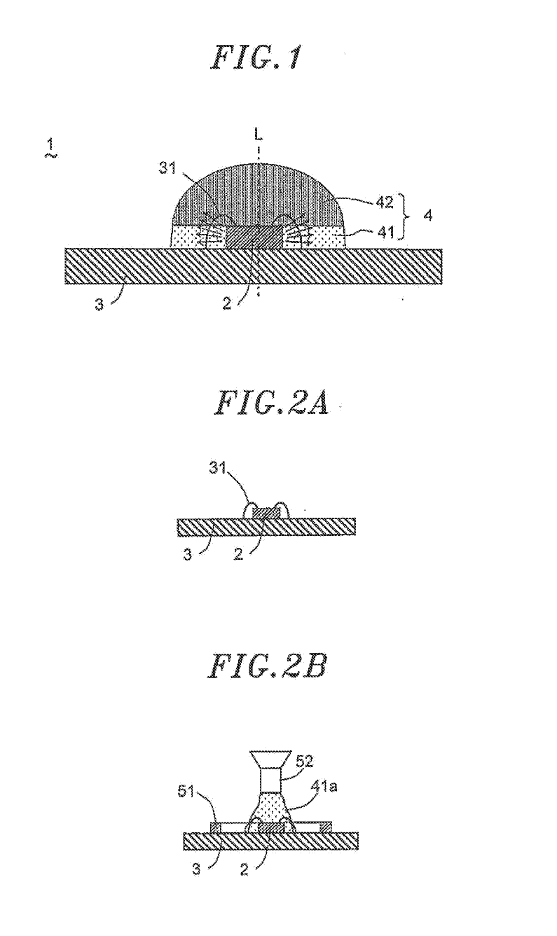

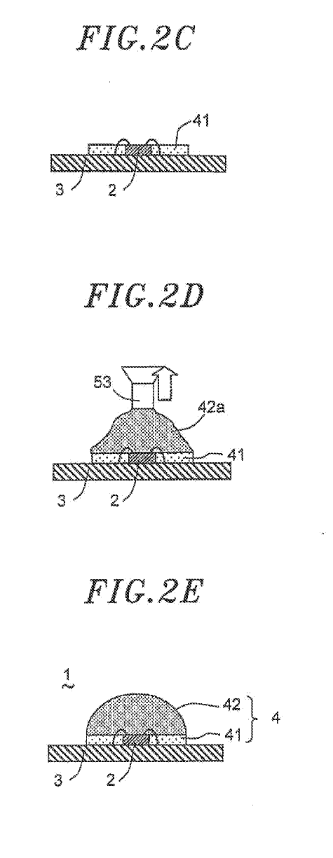

A light emitting device in accordance with a first embodiment of the present invention will now be described with reference to FIGS. 1 and 2. As shown in FIG. 1, the light emitting device 1 of the present embodiment includes a light emitting diode (hereinafter referred to as “LED”) 2 as a solid-state light emitting element, a wiring substrate (hereinafter referred to as “substrate”) 3 mounted with the LED 2 and a wavelength converting member 4 formed of a resin member containing a fluorescent material and covering the emission surface of the LED 2. The wavelength converting member 4 includes a first fluorescent material layer 41 arranged around the circumference of the LED 2 to have a height substantially equal to the height of the upper surface of the LED 2 and a second fluorescent material layer arranged to cover the LED 2 and the first fluorescent material layer 41. In the following description, the normal line passing through the center of the emission surface of the LED 2 will be referred to as “light output axis L”.

The LED 2 may be, but is not particularly limited to, a light source enabling the light emitting device 1 to emit light of a desired color. A GaN-based blue LED chip for emitting blue light having a peak emission wavelength of 460 nm is preferably used as the LED 2. In the present embodiment, a so-called face-up type element having a positive electrode and a negative electrode formed on the upper surface of the element is used as the LED 2. The LED 2 is mounted on the substrate 3 through a sub-mount made of AlN or the like. The respective electrodes arranged on the upper surface of the LED 2 are connected by wires 31 to a wiring pattern (not shown) formed on the substrate 3. Consequently, the LED 2 and the wiring pattern are electrically connected to each other. While a method of mounting a face-up type element by wire bonding is taken as one example of the method of mounting the LED 2 in the present embodiment, the LED 2 may be a face-down type element having electrodes arranged on the lower surface thereof. In this case, the LED 2 is mounted by, e.g., a flip-chip mounting method.

A ceramic substrate made of alumina or aluminum nitride superior in heat dissipation property or a metal substrate having an insulation layer formed on the surface thereof is used as the substrate 3. If the LED 2 is small in output and heat generation amount, a substrate panel made of, e.g., a glass epoxy resin or a paper phenolic resin, is preferably used as the substrate 3. A wiring pattern for supplying an electric current to the LED 2 therethrough is formed on the substrate 3. The substrate 3 may have a size and shape suitable for supporting mounted members such as the LED 2 and the wavelength converting member 4. The thickness of the substrate 3 may be set such that the substrate 3 has strength high enough not to generate deformation, e.g., bending, when in use.

The wiring pattern may be formed by plating, e.g., Au, on the substrate 3. The plating material is not limited to Au but may be, e.g., Ag, Cu or Ni. In order to increase the bonding force with respect to the substrate 3, the wiring pattern may be formed of a laminated structure of, e.g., Au/Ni/Ag. The surface of the wiring pattern may be subjected to light reflection treatment so that the wiring pattern can reflect the light emitted from the LED 2 toward the substrate 3. It is preferred that the surfaces of the substrate 3 and the wiring pattern be covered with a white resist, except the regions required for the connection of the wires 31 and for the mounting of the LED 2. The white resist is formed by, e.g., a lift-off method. This makes sure that the wiring pattern is protected by the white resist. Thus the wiring stability gets enhanced. In addition, it becomes easy to handle the light emitting device 1 when installing the light emitting device 1 into the illumination apparatus. This helps enhance the device manufacturing efficiency.

For example, general-purpose gold wires are used as the wires 31. Alternatively, the wires 31 may be aluminum wires, silver wires or copper wires. The wires 31 are bonded to the respective electrodes of the LED 2 and the wiring pattern of the substrate 3 by a well-known bonding method such as thermal bonding or ultrasonic bonding.

As set forth above, the wavelength converting member 4 is made up of the first fluorescent material layer 41 and the second fluorescent material layer 42. The second fluorescent material layer 42 is higher in fluorescent material concentration than the first fluorescent material layer 41. The lateral surface of first fluorescent material layer 41 is not covered with the second fluorescent material layer 42 and is exposed to the outside.

The first and second fluorescent material layers 41 and 42 are formed into the afore-mentioned shape by use of a material prepared by dispersedly mixing a granular yellow fluorescent material, which is excited by the blue light emitted from the LED 2 to generate yellow light, with a light-transmitting resin (e.g., a silicon resin). For example, a silicon resin having a refractive index of 1.2 to 1.5 is used as the light-transmitting resin.

A well-known yellow fluorescent material having a peak wavelength in a wavelength region of 500 nm to 650 nm, which is excited by partially absorbing the blue light emitted from the LED 2, is preferably used as the fluorescent material. The yellow fluorescent material has a peak emission wavelength belonging to a yellow wavelength region. The emission wavelength region of the yellow fluorescent material includes a red wavelength region. The yellow fluorescent material may be, but is not limited to, a so-called YAG-based fluorescent material made of Garnet-structure crystals of composite yttrium aluminum oxide. For example, fluorescent materials having different colors may be used in combination in order to adjust the color temperature and the color rendering property. White light having an enhanced color rendering property can be obtained by appropriately mixing a red fluorescent material and a green fluorescent material. In addition to the fluorescent material, a light diffusing material or a filler material may be added to the resin making up the first fluorescent material layer 41 or the second fluorescent material layer 42.

A manufacturing process of the light emitting device 1, particularly a forming process of the first and second fluorescent material layers 41 and 42, will now be described with reference to FIGS. 2A to 2E. As shown in FIG. 2A, the LED 2 is first mounted on the substrate 3. Then, as shown in FIG. 2B, a ring-shaped frame member 51 is arranged on the substrate 3 so that the center position thereof can coincide with the center of the LED 2. The frame member 51 used herein is of the type having a height equal to the distance from the mounting surface of the substrate 3 to the upper surface of the LED 2. A first resin material 41a having a low fluorescent material concentration is supplied into the frame member 51 by use of a dispenser 52. Subsequently, the first resin material 41a flowing out from the frame member 51 is removed and the first resin material 41a held within the frame member 51 is cured. After curing the first resin material 41a, a releasing agent (not shown) is supplied into between the frame member 51 and the first resin material 41a thus cured. As shown in FIG. 2C, the frame member 51 is removed, thereby forming the first fluorescent material layer 41. Subsequently, a second resin material 42a having a high fluorescent material concentration is applied on the upper surfaces of the LED 2 and the first fluorescent material layer 41 by use of the dispenser 53. The application of the second resin material 42a is continuously performed while lifting up the dispenser 53. At this time, if a material having a relatively high thixotropy is used as the second resin material 42a, it becomes easy to form the applied second resin material 42a into a desired shape. Thereafter, the second resin material 42a is cured. The second resin material 42a thus cured may be machined into a desired shape by cutting or grinding the surface of the second resin material 42a. In this manner, the second fluorescent material layer 42 is formed as shown in FIG. 2E, thereby manufacturing the light emitting device 1.

The operation of the light emitting device 1 will now be described with reference to FIG. 1. The light emitted from the LED 2 is radially projected about the light output axis L. Some parts of the light impinge against the fluorescent material contained in the wavelength converting member 4, thereby converting the fluorescent material from a ground state to an excited state. The fluorescent material converted to the excited state emits light differing in wavelength from the light emitted from the LED 2 and comes back to the ground state. Thus the fluorescent material can emit light generated by wavelength-converting the light emitted from the LED 2. The light wavelength-converted by the fluorescent material is projected not only in the direction of the light output axis L but also radially from the fluorescent material. In other words, the light emitted from the LED 2 is wavelength-converted by the fluorescent material and is radially diffused without travelling in the same direction as the moving direction of the light emitted from the LED 2. The wavelength-converted light can be further diffused by impinging against the surfaces of other fluorescent materials.

The blue light emitted from the LED 2 toward the lateral side is incident on the first fluorescent material layer 41 formed around the circumference of the LED 2. Some parts of the incident light are converted to yellow light by the fluorescent material. As a result, the blue light and the yellow light are mixed with each other, whereby white light is projected from the lateral surface of the first fluorescent material layer 41 exposed to the outside. In this regard, the concentration of the fluorescent material in the first fluorescent material layer 41 is lower than the concentration of the fluorescent material in the second fluorescent material layer 42. Therefore, the light travelling toward the first fluorescent material layer 41 is less diffused than the light travelling toward the second fluorescent material layer 42 and is continuously moved in the same direction as the moving direction of the light just emitted from the LED 2. This makes it possible to restrain a decrease in the luminous flux of the light projected from the lateral surface of the first fluorescent material layer 41 and to increase the illuminance of the light emitting device 1 in the lateral direction.

The blue light emitted from the LED 2 in the direction of the light output axis L is incident on the second fluorescent material layer 42 formed on the upper surface of the LED 2. Some parts of the incident light are converted to yellow light by the fluorescent material. Thus white light is projected from the surface of the second fluorescent material layer 42 in the same manner as mentioned above. In this regard, the concentration of the fluorescent material in the second fluorescent material layer 42 is higher than the concentration of the fluorescent material in the first fluorescent material layer 41. For that reason, the light travelling toward the second fluorescent material layer 42 is more easily diffused by the fluorescent material than the light travelling toward the first fluorescent material layer 41. Accordingly, the blue light component of the light emitted upward from the LED 2 is prevented from being too stronger and is appropriately mixed with the yellow light component. Thus color unevenness is hard to occur on the irradiated surface. In the second fluorescent material layer 42, the light having a large amount of yellow light component is more easily projected in the lateral direction than in the direction of the light output axis L. On the other hand, the light projected from the first fluorescent material layer 41 tends to have a large amount of blue light component. The light projected from the first fluorescent material layer 41 is appropriately mixed with the light laterally projected from the second fluorescent material layer 42, whereby the light hardly generating color unevenness can be projected in the lateral direction of the light emitting device 1.

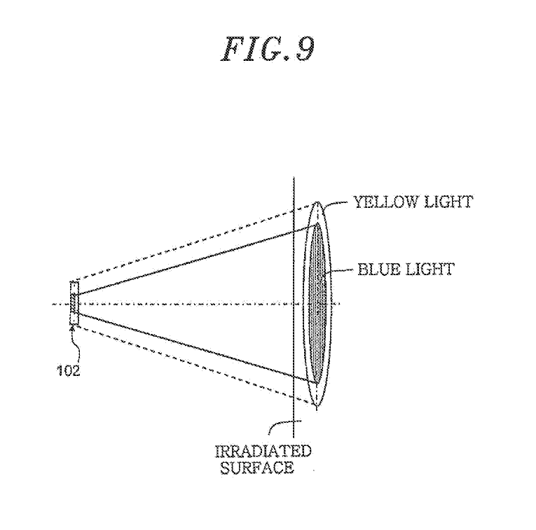

In the light emitting device 1, the blue light component of the light irradiated in the direction of the light output axis L is made smaller than in the conventional light emitting device shown in FIG. 9 by the second fluorescent material layer 42. This helps reduce color unevenness. The yellow light component of the light irradiated in the lateral direction of the LED 2 is reduced by the first fluorescent material layer 41. This helps reduce color unevenness. As a result, the light emitting device 1 as a whole can irradiate light with reduced color unevenness. Since the light is radially projected from the lateral surface of the first fluorescent material layer 41 exposed to the outside and from the second fluorescent material layer 42 higher in fluorescent material concentration than the first fluorescent material layer 41, it is possible to irradiate the light at a wide angle from the wavelength converting member 4 formed of the first and second fluorescent material layers 41 and 42. This reduces the directivity of the projected light. Accordingly, the grainy feeling specific to a LED light source can be reduced in the illumination apparatus using the light emitting device 1. The lateral surface of the wavelength converting member 4 (the first fluorescent material layer 41) is exposed to the outside and is not surrounded by a reflection mirror or the like. Therefore, there is no possibility that the light is lost by multiple reflection. This makes it possible to enhance the light utilization efficiency. In the light emitting device 1, the wavelength converting member 4 is formed on the upper surface of the flat substrate 3. It is therefore possible to flexibly cope with the change in the arrangement of LED chips in, e.g., a COB module. The light emitting device 1 can be manufactured through the same process as stated above.

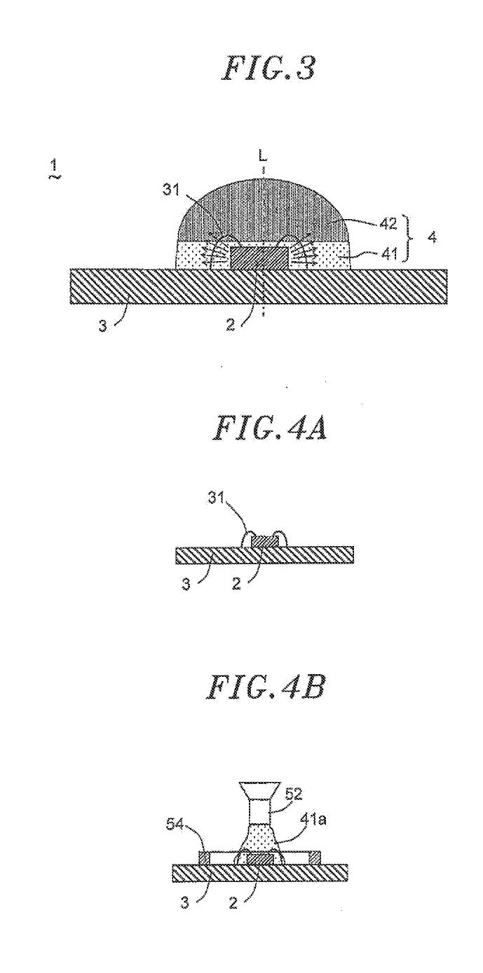

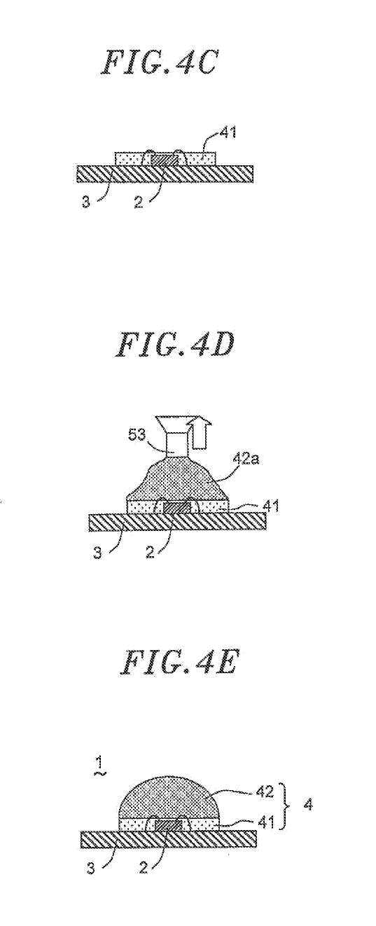

Next, a light emitting device in accordance with one modified example of the first embodiment will be described with reference to FIGS. 3 and 4. In the light emitting device 1 of this modified example, the first fluorescent material layer 41 is formed to cover, with a thin thickness, the upper surface of the LED 2. A manufacturing process of the light emitting device 1 of this modified example is shown in FIGS. 4A to 4E. Only the points differing from the first embodiment (see FIGS. 2A to 2E) will be described herein. With the light emitting device 1 of this modified example, a frame member 54 formed to have a height a little larger than the distance from the mounting surface L of the substrate 3 to the upper surface of the LED 2 is used in the step of forming the first fluorescent material layer 41 as shown in FIG. 4B. Accordingly, as shown in FIG. 4C, it is possible to make the upper surface of the first fluorescent material layer 41a little higher than the upper surface of the LED. Thus the LED 2 is covered with the first fluorescent material layer 41.

Heat generated during wavelength conversion of the light emitted from the LED 2 is accumulated in the wavelength converting member 4. This heat is generated in a larger quantity in the second fluorescent material layer 42 than in the first fluorescent material layer 41, because the second fluorescent material layer 42 is higher in the fluorescent material concentration and in the amount of luminous flux than the first fluorescent material layer 41. The second fluorescent material layer 42 is exposed to the heat generated from the LED 2. If the second fluorescent material layer 42 grows hot, the wavelength conversion efficiency of the fluorescent material gets lowered. It is therefore likely that the light emitting device 1 cannot project the light having a desired color. On the other hand, the first fluorescent material layer 41 is lower in the fluorescent material concentration than the second fluorescent material layer 42. Heat is hardly generated in the first fluorescent material layer 41 during the wavelength conversion process. Since the first fluorescent material layer 41 makes contact with the substrate 3, the first fluorescent material layer 41 shows an enhanced heat dissipation property. Thus the first fluorescent material layer 41 is less likely to grow hot than the second fluorescent material layer 42.

With this modified example, the contact area between the first fluorescent material layer 41 and the second fluorescent material layer 42 becomes larger. Accordingly, the heat generated in the second fluorescent material layer 42 can be efficiently dissipated to the substrate 3 through the first fluorescent material layer 41. Since the LED 2 and the second fluorescent material layer 42 do not make contact with each other, the heat generated in the LED 2 is hardly transferred to the second fluorescent material layer 42. This makes it possible to suppress an increase in the temperature of the second fluorescent material layer 42.

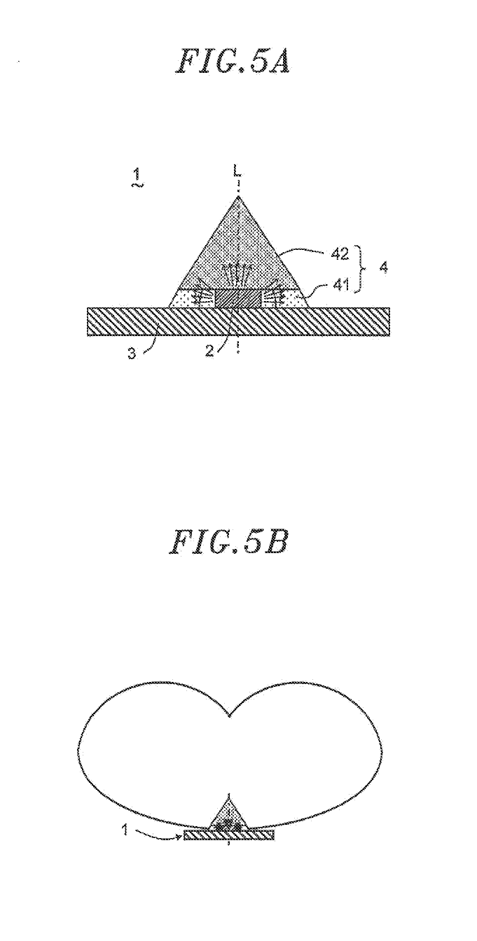

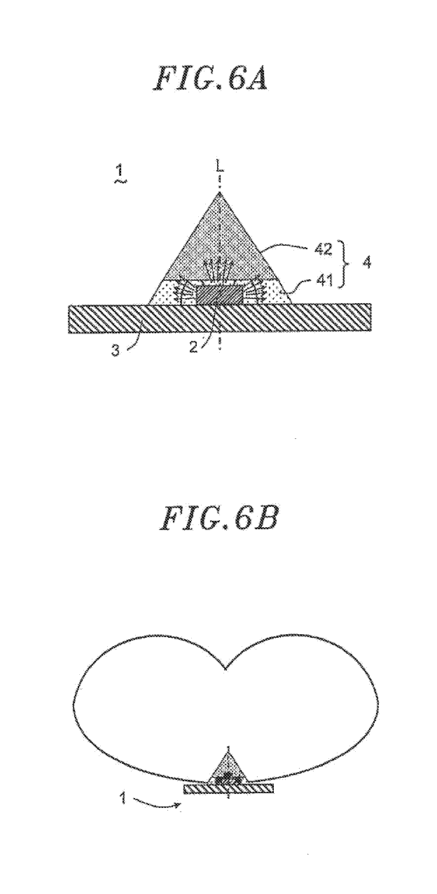

A light emitting device in accordance with another modified example of the first embodiment will now be described with reference to FIGS. 5A to 6B. As shown in FIG. 5A, the light emitting device 1 of this modified example includes a wavelength converting member 4 formed into a triangular shape when seen in a vertical section view.

In this modified example, the light emitted from the LED 2 in the direction of the light output axis L travels a longest distance within the wavelength converting member 4. Accordingly, the probability that the light moving in the direction of the light output axis L impinges against the fluorescent material is increased in proportion to the length of the distance (the length of an optical path) along which the light travels within the wavelength converting member 4. It is therefore possible to hinder the light from travelling in the direction of the light output axis L. As a result, if the thickness of the wavelength converting member 4 in the vertical direction of the LED 2 is larger than the thickness thereof in the lateral direction of the LED 2 when seen in a vertical section view, the quantity of the light travelling in the direction of the light output axis L grows smaller in proportion to the increase in the thickness of the wavelength converting member 4 in the vertical direction. The light wavelength-converted by the fluorescent material is projected substantially as diffused light (e.g., BZ5 of class BZ) with respect to the projection surface of the wavelength converting member 4. Accordingly, it is possible to obtain a laterally enlarged light distribution as the ratio of the laterally facing surface becomes greater than the ratio of the upwardly facing surface.

As shown in FIG. 5B, the light is projected from the wavelength converting member 4 to describe a so-called bat-wing-type light distribution curve in which the amount of the projected luminous flux is small in the direction of the light output axis L but large in the lateral direction. Accordingly, the light emitting device 1 can broadly distribute the light emitted from the LED 2 and can reduce the directivity specific to an LED light source.

A light emitting device in accordance with a further modified example of the first embodiment is shown in FIGS. 6A and 6B. In this modified example, just like the modified example shown in FIG. 3, the first fluorescent material layer 41 is formed to cover, with a thin thickness, the upper surface of LED 2. With this modified example, it is possible to obtain a light emitting device 1 capable of providing both the effect available in the modified example shown in FIG. 3 and the effect available in the modified example shown in FIG. 5.

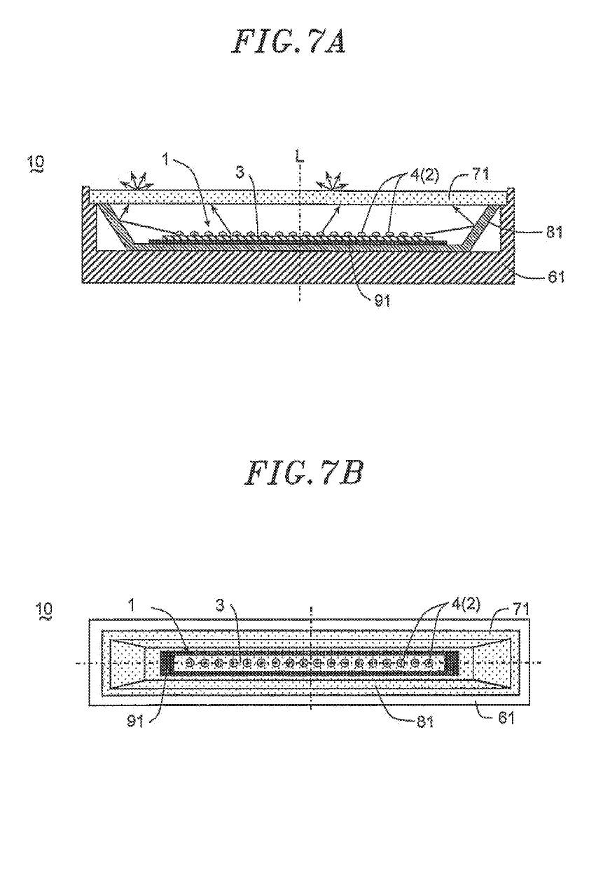

Next, a light emitting device in accordance with a second embodiment of the present invention and a illumination apparatus using the same will be described with reference to FIGS. 7A and 7B. The light emitting device 1 of the present embodiment includes a plurality of LEDs 2 arranged on an elongated rectangular substrate 3 along a line and a plurality of wavelength converting members 4 arranged on the LEDs 2. The wavelength converting members 4 are just like the wavelength converting member 4 described in respect of the first embodiment. As shown in FIGS. 7A and 7B, the light emitting device 1 is preferably used in a base-light-type illumination apparatus 10.

The illumination apparatus 10 includes a body portion 61, a light diffusing and transmitting panel (hereinafter referred to as “light diffusing panel”) 71 arranged at the light output side of the light emitting device 1 and a reflection plate 81 for reflecting the light projected from the light emitting device 1 toward the light diffusing panel 71. A heat dissipation sheet 91 for effectively dissipating heat of the light emitting device 1 toward the body portion 61 is provided between the light emitting device 1 and the body portion 61 (the reflection plate 81 in the illustrated example). In the present embodiment, the illumination apparatus 10 is illustrated in the form of an elongated rectangular base light. Alternatively, the illumination apparatus 10 may have a square shape or a circular shape. The shape of the illumination apparatus 10 is not particularly limited. A plurality of light emitting devices 1 each having a plurality of LEDs 2 arranged along a line may be employed. The LEDs 2 may be arranged on the substrate 3 in a matrix shape. A power supply unit (not shown) for turning on the light emitting device 1 is arranged within the body portion 61.

The body portion 61 is a box-shaped structural member having an open front surface. The body portion 61 is designed to accommodate the light emitting device 1 and includes a rectangular bottom wall portion larger in size than the substrate 3 and a sidewall portion protruding upward from the four edges of the bottom wall portion. The light diffusing panel 71 is attached to the opening-side edge of the sidewall portion. The body portion 61 is formed by pressing a metal plate such as an aluminum plate or a steel plate into a specified shape. The inner surface of the body portion 61 may be coated with a white paint.

The light diffusing panel 71 is a rectangular plate-like member obtained by forming an opaque material, which is made of a light-transmitting resin such as an acryl resin containing light diffusing particles such titanium oxide particles, into a shape substantially conforming to the inner edge shape of the opening of the body portion 61. Alternatively, the light diffusing panel 71 may be a transparent glass plate or a transparent resin plate whose front surface or rear surface is roughened by sandblasting or subjected to surface texturing.

The reflection plate 81 is formed of a reflective curved plate and is arranged to surround the LEDs 2 and the wavelength converting members 4 arranged on the substrate 3 along a line. The reflection plate 81 is inclined with respect to the light output axis L. The reflection plate 81 may preferably be a light diffusing reflection plate formed by, e.g., coating a highly-reflective white paint on a resin-made structural body having a basin-like shape. If the illumination apparatus 10 is used as, e.g., a down-light, it may be possible to use a reflection plate whose surface is deposited with highly-reflective silver or aluminum.

The heat dissipation sheet 91 is a sheet-like member made of an epoxy resin filled with a filler material such as alumina or silica at a high concentration. The heat dissipation sheet 91 has an insulation property. By mixing the filler material, the heat dissipation sheet 91 is formed to have a relatively high heat conductivity (e.g., about 3 W/m·K). The heat dissipation sheet 91 has a thickness of about 100 μm and tends to show a reduced viscosity when heated. Accordingly, the heat dissipation sheet 91 can be made thinner than a typical rubber-made heat dissipation sheet. As a result, the heat dissipation sheet 91 has a reduced thermal resistance and can efficiently dissipate heat toward the body portion 61.

In the illumination apparatus 10 configured as above, the light emitted from the light emitting device 1 is directly incident on the light diffusing panel 71 or is reflected by the reflection plate 81 and then incident on the light diffusing panel 71. Thereafter, the light is projected outside the illumination apparatus 10. At this time, even if the light diffusing panel 71 is arranged adjacent to the light emitting device 1, the directivity of the light incident on the light diffusing panel 71 becomes lower because the light emitting device 1 projects the light at a wide angle as set forth above. The light is further diffused by the light diffusing panel 71 and then projected. Accordingly, the illumination apparatus 10 can make the light diffusing panel 71 look shiny as a whole and can make the illuminance distribution of the light diffusing panel 71 uniform. Not only the illuminance unevenness but also the color unevenness can be kept small. It is therefore possible to arrange the light diffusing panel 71 adjacent to the light emitting device 1 and to reduce the thickness of the illumination apparatus 10. The grainy feeling specific to a LED light source can be suppressed and the surface reflection can be reduced on the projection surface of the light diffusing panel 71 of the illumination apparatus 10.

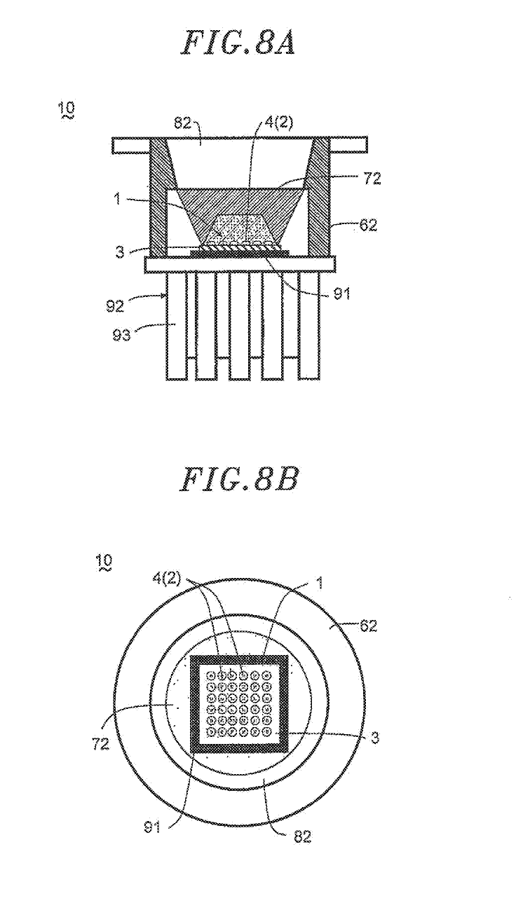

A light emitting device in accordance with one modified example of the second embodiment and a illumination apparatus using the same will now be described with respect to FIGS. 8A and 8B. The light emitting device 1 of this modified example includes a plurality of LEDs 2 arranged on a circular substrate 3 in a matrix shape and a plurality of wavelength converting members 4 arranged on the LEDs 2. The wavelength converting members 4 are just like the wavelength converting member 4 described in respect of the first embodiment. As shown in FIGS. 8A and 8B, the light emitting device 1 is preferably used in a down-light-type illumination apparatus 10.

The illumination apparatus 10 includes a frame body 62 for keeping the illumination apparatus 10 held in an opening formed on an installation surface (e.g., a ceiling), a collecting lens 72 for collecting the light emitted from the light emitting device 1 and a reflection member 82 for controlling the distribution of light projected from the collecting lens 72. The illumination apparatus 10 further includes a heat sink member 92 attached to the rear surface of the light emitting device 1 to dissipate heat of the light emitting device 1 and a heat dissipation sheet 91 arranged between the light emitting device 1 and the heat sink member 92 to effectively dissipate heat of the light emitting device 1 toward radiator fins 92.

The frame body 62 is a tubular member having an opening through which to project light. A flange to be held in the opening of the installation surface is formed in the peripheral edge of the opening of the frame body 62. The frame body 62 is made of the same material as the material of the body portion 61 of the foregoing embodiment. A claw for holding the collecting lens 72 is formed on the inner surface of the tubular portion of the frame body 62. A light-reflecting metallic material is deposited on the area extending from the claw to the opening of the frame body 62. The metallic material thus deposited serves as the reflection member 82. The shape of the reflection member 82 is designed so that the light irradiation angle of the illumination apparatus 10 can be controlled at a specified angle.

The collecting lens 72 is formed by injection-molding a light-transmitting material such as a transparent acryl resin into a cylindrical closed-bottom shape. A lens array including a plurality of lens member may be provided in alignment with the installation position of the LEDs 2. In order for a yellow ring generated by the LEDs 2 not to be projected on an irradiated surface, it is preferred that the collecting lens 72 be formed to have a scattering property by subjecting the light exit surface thereof to a dimple formation process.

The heat dissipation sheet 91 is the same one as employed in the foregoing embodiment and is formed into a circular shape to correspond to the shape of the substrate 3.

The heat sink member 92 is made of, e.g., aluminum alloy, and is preferably formed by general-purpose aluminum die casting. A plurality of radiator fins 93 is arranged on the outer circumferential surface of the heat sink member 92 in order to increase the surface area making contact with the ambient air and to enhance the heat dissipation property. A space that accommodates a power supply unit (not shown) for turning on the light emitting device 1 is provided inside the heat sink member 92.

In this modified example, the light emitting device 1 is capable of irradiating the light at a wide angle. By adjusting the shape or the like of the collecting lens 72 and the reflection member 82, it is possible to realize a illumination apparatus 10 with enhanced light distribution controllability.

The present invention is not limited to the embodiments described above but may be modified in many different forms. In the second embodiment, the wavelength converting members 4 are provided in one-to-one correspondence to the LEDs 2 arranged along a line. Alternatively, the LEDs 2 may be covered with a single wavelength converting member 4. In this case, the wavelength converting member 4 is formed into, e.g., a trough shape. If the first fluorescent material layer 41 is formed to extend in the direction orthogonal to the longitudinal direction of the wavelength converting member 4, it is possible to promise the same effects as provided by the foregoing embodiments, as far as the light emission characteristics in that direction is concerned.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A light emitting device, comprising:
a solid-state light emitting element;
a substrate mounted with the solid-state light emitting element; and
a wavelength converting member covering an emission surface of the solid-state light emitting element, the wavelength converting member being formed of a transparent resin containing a fluorescent material,
wherein the wavelength converting member includes a first fluorescent material layer provided around the solid-state light emitting element, the first fluorescent material layer being substantially equal in height to an upper surface of the solid-state light emitting element, and a second fluorescent material layer provided to cover the solid-state light emitting element and the first fluorescent material layer, and
wherein the second fluorescent material layer is higher in fluorescent material concentration than the first fluorescent material layer, the first fluorescent material layer having a lateral surface exposed and not covered with the second fluorescent material layer.

2. The device of claim 1, wherein the first fluorescent material layer is formed to cover, with a thin thickness, the upper surface of the solid-state light emitting element.

3. The device of claim 1, wherein the wavelength converting member is formed to have a triangular shape when seen in a vertical section view.

4. The device of claim 2, wherein the wavelength converting member is formed to have a triangular shape when seen in a vertical section view.

5. An illumination apparatus comprising the light emitting device of claim 1.

6. An illumination apparatus comprising the light emitting device of claim 2.

7. An illumination apparatus comprising the light emitting device of claim 3.

8. An illumination apparatus comprising the light emitting device of claim 4.
